(19) United States
(12) Patent Application Publication
(10) Pub. No.: US 2019/0278318 A1
(43) Pub. Date: Sep. 12, 2019

(54) PEDAL EFFORT GENERATOR USING CAM

(71) Applicant: Kyung Chang Industrial Co., Ltd., Daegu (KR)

(72) Inventors: Min Seong Park, Daegu (KR); Kwang Jin Michael Lee, Daegu (KR)

(73) Assignee: Kyung Chang Industrial Co., Ltd., Daegu (KR)

(21) Appl. No.: 16/296,782

(22) Filed: Mar. 8, 2019

(30) Foreign Application Priority Data
Mar. 8, 2018 (KR) 1020180027558
May 17, 2018 (KR) 1020180056476

(51) Int. Cl. G05G 1/44

(52) U.S. Cl. CPC G05G 1/44

(57) ABSTRACT

A pedal effort generator using a cam may be provided that includes: a housing which includes a rotating shaft disposed therewithin; a cam which is disposed on an inner surface of the housing; a pedal effort generation unit which moves along one surface of the cam; a pedal unit which includes a pedal pad disposed on one side thereof and includes a receiving recess in which a portion of the pedal effort generation unit is disposed on the other side thereof, a portion of between the one side and the other side which is connected to the rotating shaft of the housing and is pivotable about the rotating shaft; and an elastic member which is disposed between the inner surface of the housing and the other side of the pedal unit to apply an elastic force to the pedal unit. The pedal effort generation unit includes a roller unit which moves along one surface of the cam by the pivoting of the pedal unit and includes a spring which is coupled to the roller unit. The roller unit includes a roller which moves along the one surface of the cam and includes a roller support which supports the roller. The spring is disposed below the roller support.

### BACKGROUND

### Field

The present disclosure relates to a pedal which is used in a vehicle, etc., and more particularly to a pedal effort generator which generates pedal effort by using a cam.

### Description of the Related Art

In general, a pedal which is used in a vehicle includes an accelerator pedal, a clutch pedal, and a brake pedal.

Various kinds of pedals which are commonly used in a vehicle may generally include a pedal on which a user's foot steps, an elastic member (e.g., a spring) which returns the pedal to its original position after the user steps on the pedal, and a component which generates pedal effort.

Regarding the accelerator pedal, the clutch pedal, and the brake pedal which have been employed so far, components generating the pedal effort suitable for the user are difficult to simply change. Also, there are problems in that they have complicated structures and use many parts.

### SUMMARY

One embodiment is a pedal effort generator using a cam. The pedal effort generator includes: a housing which includes a rotating shaft disposed therewithin; a cam which is disposed on an inner surface of the housing; a pedal effort generation unit which moves along one surface of the cam; a pedal unit which includes a pedal pad disposed on one side thereof and includes a receiving recess in which a portion of the pedal effort generation unit is disposed on the other side thereof, a portion of between the one side and the other side which is connected to the rotating shaft of the housing and is pivotable about the rotating shaft; and an elastic member which is disposed between the inner surface of the housing and the other side of the pedal unit to apply an elastic force to the pedal unit.

The pedal effort generation unit includes a roller unit which moves along one surface of the cam by the pivoting of the pedal unit and includes a spring which is coupled to the roller unit.

The roller unit includes a roller and a roller support which supports the roller. The spring is disposed below the roller support. The roller moves along the one surface of the cam.

A length of the spring changes by the movement of the roller unit on the one surface of the cam, and the length change of the spring generates the pedal effort.

Another embodiment is a pedal effort generator using a cam. The pedal effort generator includes: a housing which includes a rotating shaft disposed therewithin; a cam which is disposed on an inner surface of the housing; a pedal effort generation unit which moves along one surface of the cam; a pedal unit which includes one side and the other side, the one side including a pedal pad and a receiving hole in which a portion of the pedal effort generation unit is disposed, a portion of between the one side and the other side which is connected to the rotating shaft of the housing and is pivotable about the rotating shaft; and an elastic member which is disposed between the inner surface of the housing and the other side of the pedal unit to apply an elastic force to the pedal unit.

The pedal unit further includes a bush member which is connected to the rotating shaft.

The pedal effort generation unit includes a roller unit moving along one surface of the cam by the pivoting of the pedal unit, includes a spring which is coupled to the roller unit, and includes a receiving portion which receives the spring.

The roller unit includes a roller and a roller support which supports the roller. The spring is disposed below the roller support. The roller moves along the one surface of the cam.

The pedal unit further includes a bush member which is connected to the rotating shaft. One side of the receiving portion comes in contact with the bush member. The receiving portion transmits an elastic force which is generated in the spring by the movement of the roller unit on the one surface of the cam to the bush member, so that the pedal effort is generated.

### BRIEF DESCRIPTION OF THE DRAWINGS

FIG. 1 is a perspective view showing a pedal effort generator according to a first embodiment of the present invention;

FIG. 2 is an exploded perspective view of the pedal effort generator of FIG. 1;

FIG. 3 is a cross sectional view of the pedal effort generator of FIG. 1;

FIG. 4 is a view showing a cam of FIG. 2;

FIG. 5 shows a first embodiment showing a pedal effort generating unit of FIG. 2;

FIG. 6 shows a second embodiment showing the pedal effort generating unit of FIG. 2;

FIG. 7 shows a third embodiment showing the pedal effort generating unit of FIG. 2;

FIG. 8 is a view showing an embodiment in which the position of an elastic member is changed in the pedal effort generator of FIG. 1;

FIG. 9 is a conceptual view showing an example in which the positions of the cam and the pedal effort generating unit are changed in the pedal effort generator according to the first embodiment of the present invention;

FIG. 10 shows an experimental data of a case where the pedal effort generator according to the first embodiment of the present invention is applied to a clutch pedal;

FIG. 11 shows an experimental data of a case where the pedal effort generator according to the first embodiment of the present invention is applied to a brake pedal;

FIG. 12 is a perspective view showing a pedal effort generator according to the second embodiment of the present invention;

FIG. 13 is an exploded perspective view of the pedal effort generator of FIG. 12;

FIG. 14 is a cross sectional view of the pedal effort generator of FIG. 12; and

FIG. 15 is a view showing a principle of generating the pedal effort in the pedal effort generator of FIG. 12.

### DETAILED DESCRIPTION

Embodiments of the present invention will be described in detail with reference to the accompanying drawings. In the components of the present invention, detailed descriptions of what can be clearly understood and easily carried into practice through prior art by those skilled in the art will be omitted to avoid making the subject matter of the present invention unclear.

Hereinafter, a pedal effort generator using a cam in accordance with an embodiment of the present invention will be described.

In the pedal effort generator using a cam in accordance with the embodiment of the present invention, the pedal effort can be freely changed according to the shape of the cam, and the pedal effort generator has a simple structure and excellent durability.

### First Embodiment 100

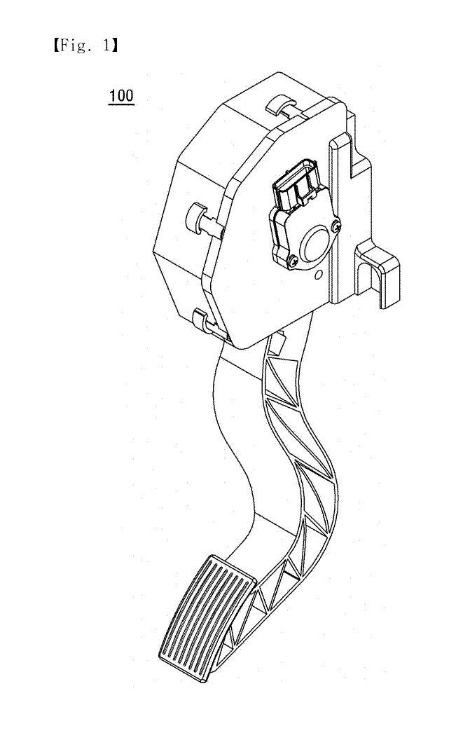

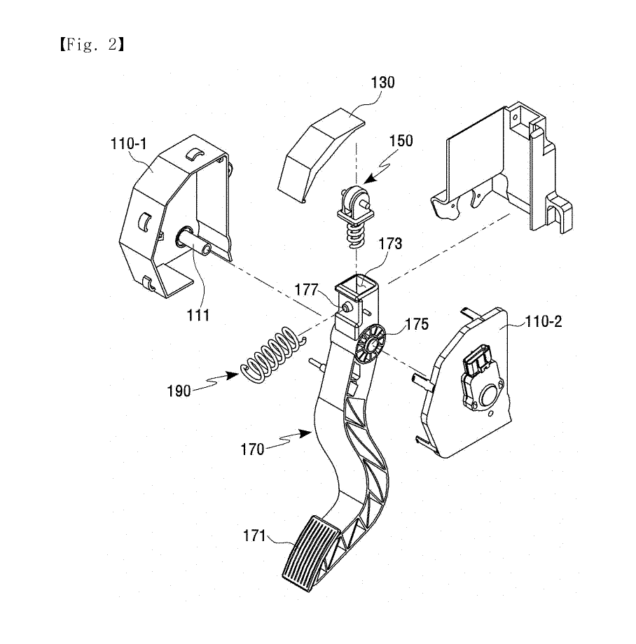

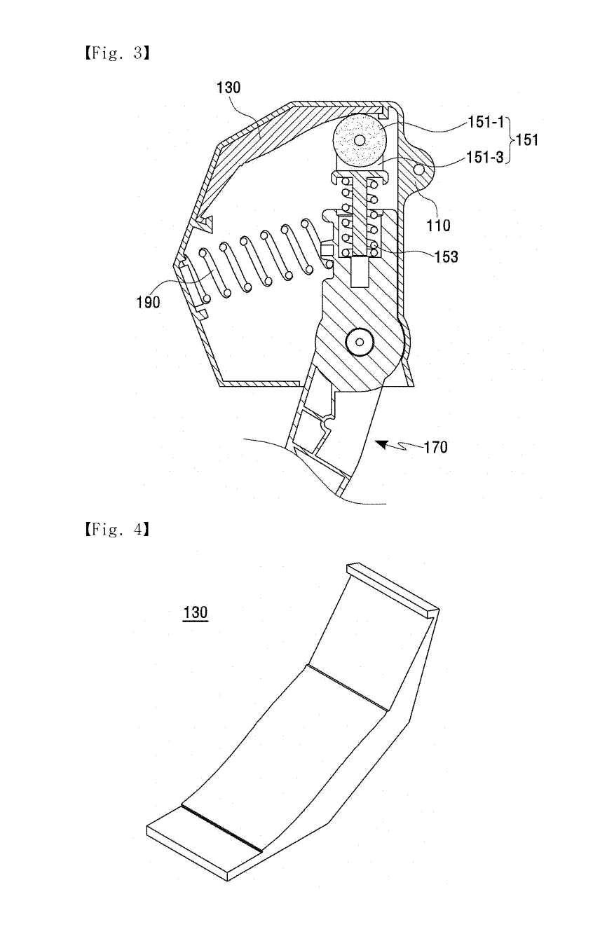

FIG. 1 is a perspective view showing a pedal effort generator according to a first embodiment of the present invention. FIG. 2 is an exploded perspective view of the pedal effort generator of FIG. 1. FIG. 3 is a cross sectional view of the pedal effort generator of FIG. 1.

Referring to FIGS. 1 to 3, the pedal effort generator using a cam 130 according to the first embodiment of the present invention may include a housing 110, a pedal unit 170, the cam 130, a pedal effort generation unit 150, and an elastic member 190. Hereinafter, the components will be each described in detail.

The housing 110 of the pedal effort generator according to the first embodiment of the present invention forms the exterior of the pedal effort generator.

The housing 110 is mounted within a vehicle and has an inner space for receiving various components of the pedal effort generator according to the first embodiment of the present invention. Specifically, the housing 110 can receive the pedal unit 170, the cam 130, the pedal effort generation unit 150, the elastic member 190, etc.

The housing 110 may be formed by a combination (coupling) of various components constituting the housing 110. For example, the housing 110 may be formed by a combination (coupling) of various components, for example, by the coupling of an upper housing and a lower housing or by the coupling of a left housing 110-1 and a right housing 110-2. Various coupling methods including a bolt-fastening method can be applied without particularly being limited.

The outer shape of the housing 110 is not specially determined. The housing 110 may have various outer shapes to which various components constituting the pedal effort generator can be fixed and coupled.

The inner shape of the housing 110 is not specially determined. The interior of the housing 110 may have receivers in which various components constituting the pedal effort generator can be received, and the housing 110 may have various inner shapes to which various components can be fixed and coupled.

A rotating shaft 111 may be disposed within the housing 110. The below-described pedal unit 170 may be connected (fastened) to the rotating shaft 111. The pedal unit 170 is connected to the rotating shaft 111 of the housing 110 and may pivot about the rotating shaft 111. The rotating shaft 111 may be integrally formed with the housing 110 or may be separately manufactured and be coupled to the housing 110.

The pedal unit 170 of the pedal effort generator according to the first embodiment of the present invention refers generally to a portion on which a user's foot steps. Specifically, one side of the pedal unit 170 may correspond to a portion on which a user's foot steps, and the below-described pedal effort generation unit 150 may be formed or disposed on the other side of the pedal unit 170.

The pedal unit 170 refers generally to a pedal that is manufactured in various shapes and is used in vehicles. The pedal unit 170 according to the embodiment of the present invention may include a pedal pad 171 and a receiving recess 173.

The pedal pad 171 is disposed on one side of the pedal unit 170 and is stepped on by a user's foot. The pedal pad 171 may be formed in various shapes so as to allow the user's foot to be comfortably placed thereon.

The receiving recess 173 may be disposed on the other side of the pedal unit 170. A portion of the below-described pedal effort generation unit 150 may be disposed in the receiving recess 173.

The cross sectional shape of the receiving recess 173 may be formed to correspond to that of the pedal effort generation unit 150 to be inserted into the receiving recess 173. However, the cross section of the receiving recess 173 is not limited to this and may have various shapes.

Further, the pedal unit 170 may include a connection portion 175 such as a hole which can be connected to the rotating shaft 111 of the housing 110. Specifically, the rotating shaft 111 of the housing 110 may be connected to a portion between one side and the other side of the pedal unit 170, and the pedal unit 170 may pivot about the rotating shaft 111 of the housing 110. Here, the portion may be the connection portion 175 like a hole. The connection portion 175 may be directly connected to the rotating shaft 111 of the housing 110 or may be indirectly connected to the rotating shaft 111 of the housing 110 by additional components.

A below-described elastic member receiving portion 177 which contacts the other side of elastic member 190 may be formed on the other side of the pedal unit 170.

The elastic member receiving portion 177 may be formed on one surface forming the other side of the pedal unit 170. The elastic member receiving portion 177 may be formed in a shape including a recess or a protrusion so as to allow the other side of the elastic member 190 to be fixed (fastened). Also, there may exist additional components capable of fixing the other side of the elastic member 190.

The cam 130 of the pedal effort generator according to the first embodiment of the present invention may be disposed on the inner surface of the housing 110.

FIG. 4 is a view showing the cam 130 of FIG. 2.

Referring to FIG. 4, the cam 130 may include one surface on which a below-described roller unit 151 of the pedal effort generation unit 150 moves and the other surface which is coupled to the inner surface of the housing 110.

In accordance with the first embodiment of the present invention, the one surface and the other surface of the cam 130 may be formed as a flat surface or may be formed as a curved or stepped surface.

A roller 151-1 of the roller unit 151 passes the one surface of the cam 130 while rotating by the pivoting of the pedal unit 170, so that the pedal effort can be variously generated according to the shape of the one surface of the cam 130.

By varying the shape of the cam 130 profile, which is formed on the one surface of the cam 130, the pedal effort can be easily generated in various patterns in accordance with a working distance of the roller 151-1 of the roller unit 151 passes. The shape of the one surface of the cam 130 shown in FIG. 4 is just an example. The one surface of the cam 130 may be formed in various shapes in accordance with required pedal effort patterns.

Since the other surface of the cam 130 is coupled to the inner surface of the housing 110, the other surface of the cam 130 may be formed in a shape corresponding to the inner surface of the housing 110. Specifically, as long as the inner surface of the housing 110 where the cam 130 is disposed is a curved or stepped surface, the cam 130 may be formed in a shape corresponding thereto.

The pedal effort generation unit 150 of the pedal effort generator according to the first embodiment of the present invention may move along the one surface of the cam 130 by the pivoting of the pedal unit 170 and may include the roller unit 151 and a spring 153. Specifically, the roller unit 151 may move along the one surface of the cam 130 by the pivoting of the pedal unit 170, and the spring 153 may be coupled to the roller unit 151.

The roller unit 151 may include the roller 151-1 and a roller support 151-3 which supports the roller 151-1. The roller 151-1 and the roller support 151-3 may be separately manufactured and coupled to each other.

The roller 151-1 may move along the one surface of the cam 130 by the pivoting of the pedal unit 170.

The roller 151-1 is formed in the form of a rotating cylinder and is able to reduce movement resistance by changing sliding friction into rolling friction. The roller 151-1 of the pedal effort generator according to the first embodiment of the present invention includes a roller which is commonly used on the market. The shape, material, and operation method of the roller 151-1 can be selected to suit the pedal effort generator required by the user.

The roller 151-1 may be disposed on one side of the roller support 151-3, and the spring 153 may be disposed on the other side of the roller support 151-3.

Specifically, the roller support 151-3 may include a fixing member, a supporting member, and a coupling member.

The fixing member of the roller support 151-3 may be connected to the central portion of the roller 151-1 such that the roller 151-1 disposed on one side of the roller support 151-3 can rotate. The supporting member may support the roller 151-1 and one side of the supporting member may be connected to the fixing member. The coupling member may be connected to the other side of the supporting member and may be coupled to the below-described spring 153 disposed on the other side of the roller support 151-3. The fixing member, the supporting member, and the coupling member may be integrally formed with each other or may be separately manufactured and coupled.

The spring 153 absorbs or accumulates energy by using elastic deformation of an object and acts as a buffer, etc. According to the first embodiment of the present invention, a typical spring may be used. Also, a variety of elastic objects or elastic devices other than the spring 153 may be used.

The spring 153 may be disposed on the other side of the roller support 151-3, that is, below the roller support 151-3. Specifically, the spring 153 may be disposed on the coupling member connected to the other side of the supporting member of the roller support 151-3. Also, the spring 153 may be disposed in receiving recess 173 formed on the other side of the pedal unit 170.

As the roller 151-1 of the roller unit 151 moves along one surface of the cam 130 by rotating, the length of the spring 153 may change and the length change of the spring 153 may generate an elastic force (pedal effort).

By varying the shape of the one surface of the cam 130, the length of the spring 153 may variously change by the roller 151-1 moving along the one surface of the cam 130. Accordingly, the pedal efforts that the user wants can be variously obtained. In other words, by varying the shape of the one surface of the cam 130, the pedal effort that the user wants can be variously obtained.

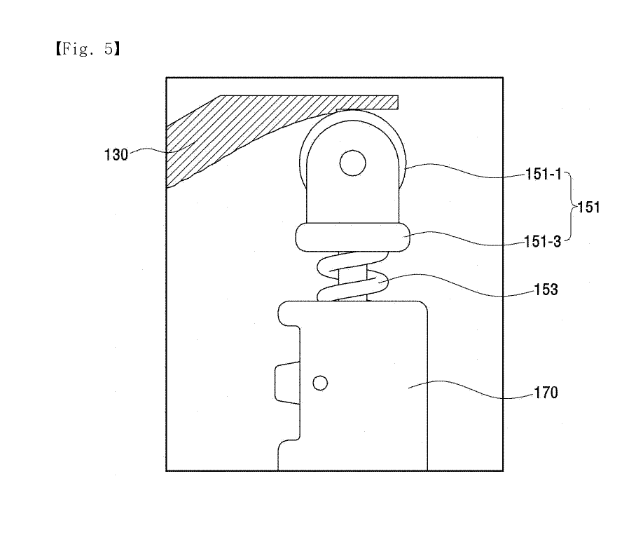

A portion of the pedal effort generation unit 150 may be disposed in the receiving recess 173 formed on the other side of the pedal unit 170. According to the first embodiment of the present invention, a portion of the roller support 151-3 and/or a portion of the spring 153 may be disposed in the receiving recess 173. This is shown in FIGS. 5 to 7.

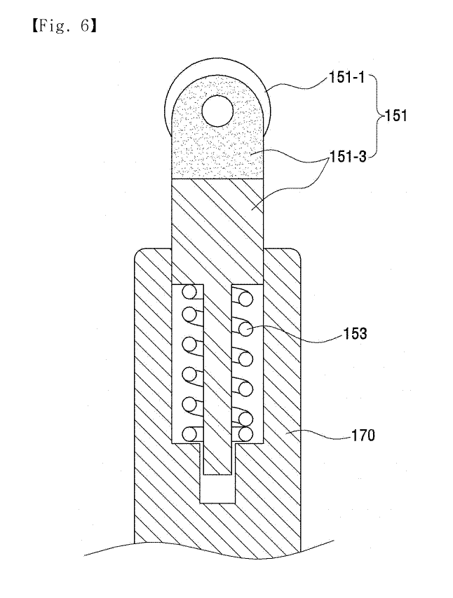

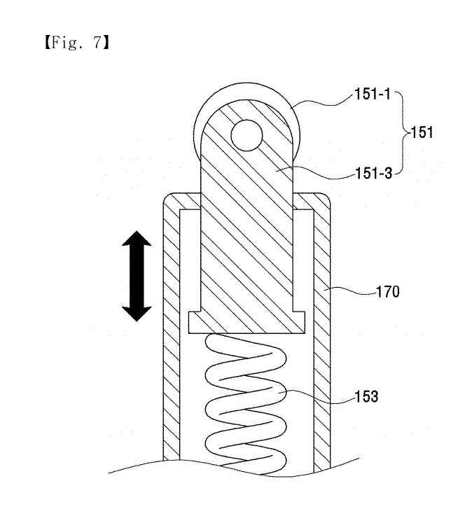

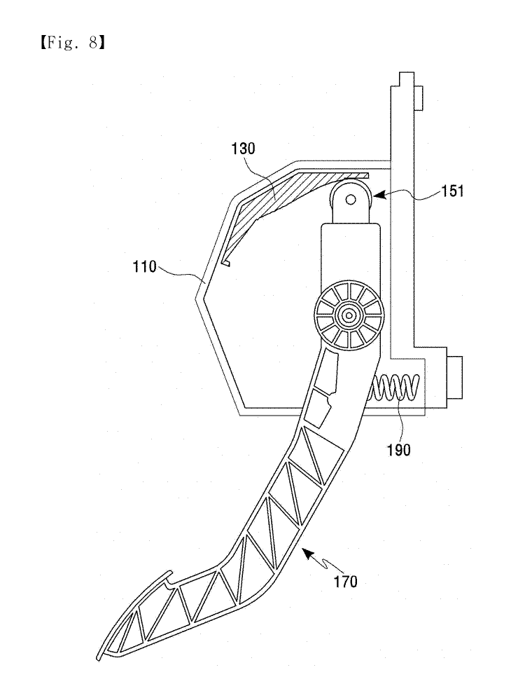

FIG. 5 shows the first embodiment showing the pedal effort generating unit 150 of FIG. 2. FIG. 6 shows a second embodiment showing the pedal effort generating unit 150 of FIG. 2. FIG. 7 shows a third embodiment showing the pedal effort generating unit 150 of FIG. 2.

Referring to FIGS. 5 to 7, in the pedal effort generator according to the first embodiment of the present invention, the pedal effort generation unit 150 and the receiving recess 173 formed on the other side of the pedal unit 170 may be variously formed and/or manufactured.

FIG. 5 shows that the roller 151-1 and a portion of the roller support 151-3 of the roller unit 151 are disposed outside the receiving recess 173 formed on the other side of the pedal unit 170 and a portion of the spring 153 is disposed within the receiving recess 173 and a remaining portion of the spring 153 is disposed outside the receiving recess 173. FIGS. 6 and 7 show that a portion of the roller support 151-3 and the spring 153 are disposed within the receiving recess 173 and a remaining portion of the roller support 151-3 and the roller 151-1 are disposed outside the receiving recess 173.

As shown in FIGS. 5 to 7, the arrangement relationship between the roller 151-1 and the spring 153 of the pedal effort generation unit 150 and the shape of the receiving recess 173 which receives a portion of the pedal effort generation unit 150 may be variously formed according to the embodiment and are not limited to the embodiments shown in FIGS. 5 to 7.

Referring to FIGS. 2 to 7, the receiving recess 173 which receives a portion of the pedal effort generation unit 150 is formed on the other side of the pedal unit 170. However, according to the first embodiment of the present invention, a case (not shown) having the receiving recess 173 formed therein may be separately manufactured and coupled to the other side of the pedal unit 170.

As shown in FIGS. 2 to 7, the receiving recess 173 may be integrally formed with the other side of the pedal unit 170. Alternatively, the case having the receiving recess 173 formed therein and the other side of the pedal unit 170 may be separately manufactured respectively and then fastened to each other in various ways.

When the case having the receiving recess 173 in which a portion of the pedal effort generation unit 150 is disposed is separately manufactured and is coupled to the other side of the pedal unit 170, the case may be made of the same material as that of the pedal unit 170. For example, when the pedal unit 170 is made of a metallic material including iron or an alloy including iron, the case may be also made of the same material as that of the pedal unit 170.

The case may be made of a different material from that of the pedal unit 170. For example, the pedal unit 170 may be made of a metallic material including iron or an alloy including iron and the case may be made of plastic, and vice versa. However, when the case is made of plastic, it is necessary to consider the shape of the plastic, etc., in order that durability can be guaranteed against fatigue fracture due to user's repeated use of the pedal.

The elastic member 190 of the pedal effort generator according to the first embodiment of the present invention is disposed between the inner surface of the housing 110 and the other side of the pedal unit 170 to apply an elastic force to the pedal unit 170.

FIG. 8 is a view showing an embodiment in which the position of the elastic member 190 is changed in the pedal effort generator of FIG. 1.

Referring to the pedal effort generator shown in FIGS. 2 and 3 and the pedal effort generator shown in FIG. 8, the elastic member 190 can be placed in various locations within the housing 110. According to the first embodiment of the present invention, the elastic member 190 may be placed outside the housing 110.

One side of the elastic member 190 shown in FIGS. 2 and 3 may contact with the inner surface of the housing 110, and the other side of the elastic member 190 may contact with the other side of the pedal unit 170. Specifically, the other side of the elastic member 190 may be disposed in the elastic member receiving portion 177 formed on the other side of the pedal unit 170.

The elastic member receiving portion 177 may be formed on one surface forming the other side of the pedal unit 170 or may be formed in a shape including a recess or a protrusion so as to allow the other side of the elastic member 190 to be fixed (fastened). Also, there may exist additional components capable of fixing the other side of the elastic member 190.

Contrary to this, one side of the elastic member 190 shown in FIG. 8 contacts with another inner surface of the housing 110 and the other side of the elastic member 190 may contact with one surface of the pedal unit 170. The one surface of the pedal unit 170, which contacts the other side of the elastic member 190, may be formed in a recess shape or a protrusion shape so as to allow the other side of the elastic member 190 to be fixed (fastened). Further, there may exist additional components capable of fixing the other side of the elastic member 190. The elastic member 190 shown in FIGS. 2 and 3 and the elastic member 190 shown in FIG. 8 are placed at positions opposite to each other with respect to the pedal unit 170.

According to the first embodiment of the present invention, the other side of the elastic member 190 shown in FIG. 8 may contact with one surface of the other side of the pedal unit 170 disposed between the rotating shaft 111 and the roller unit 151.

The elastic member 190 absorbs or accumulates energy by using elastic deformation of an object and acts as a buffer, etc. According to the first embodiment of the present invention, a typical spring may be used. Also, a variety of elastic objects or elastic devices other than the spring may be used.

When the user pivots the pedal unit by applying force to the pedal pad 171, the elastic member 190 may return the pedal unit which has pivoted at an angle in a predetermined range to its original position.

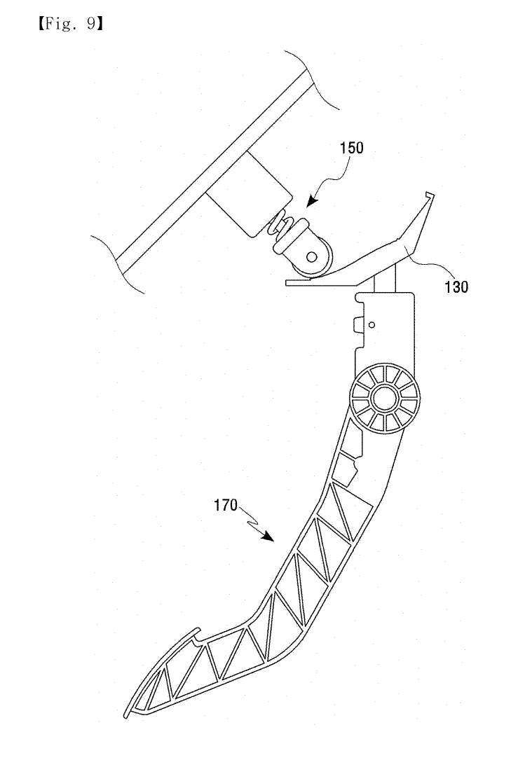

FIG. 9 is a conceptual view showing an example in which the positions of the cam 130 and the pedal effort generating unit 150 are changed in the pedal effort generator according to the first embodiment of the present invention.

Referring to FIG. 9, unlike the pedal effort generator according to the first embodiment of the present invention shown in FIGS. 2 to 8, in the pedal effort generator according to the first embodiment of the present invention shown in FIG. 9, the cam 130 may include one surface on which the roller 151-1 moves while rotating and the other surface which is coupled to the pedal unit 170.

The pedal unit 170 of the pedal effort generator according to the first embodiment of the present invention shown in FIG. 9 may include one side and the other side. The rotating shaft 111 which is connected to the housing 110 or is integrally formed with the housing 110 is fastened between the one side and the other side of the pedal unit 170, so that the connection portion 175 like a hole on which the pedal unit 170 can pivot may be formed.

The pedal pad 171 disposed (formed) on one side of the pedal unit 170 may be a portion which is stepped on by a user's foot. The cam 130 may be formed or disposed on the other side of the pedal unit 170. The pedal unit 170 and the cam 130 may be integrally formed with each other or may be separately manufactured respectively and fastened to each other in various ways.

The positions of the cam 130 and the pedal effort generation unit 150 of the pedal effort generator according to the first embodiment of the present invention shown in FIGS. 2 to 8 have been exchanged with each other in the pedal effort generator according to the first embodiment of the present invention shown in FIG. 9.

The purposes, structures, effects, etc., of the cam 130 and the pedal effort generation unit 150 of the pedal effort generator according to the first embodiment of the present invention shown in FIG. 9 are the same as those of the cam 130 and the pedal effort generation unit 150 of the pedal effort generator according to the first embodiment of the present invention shown in FIGS. 2 to 8.

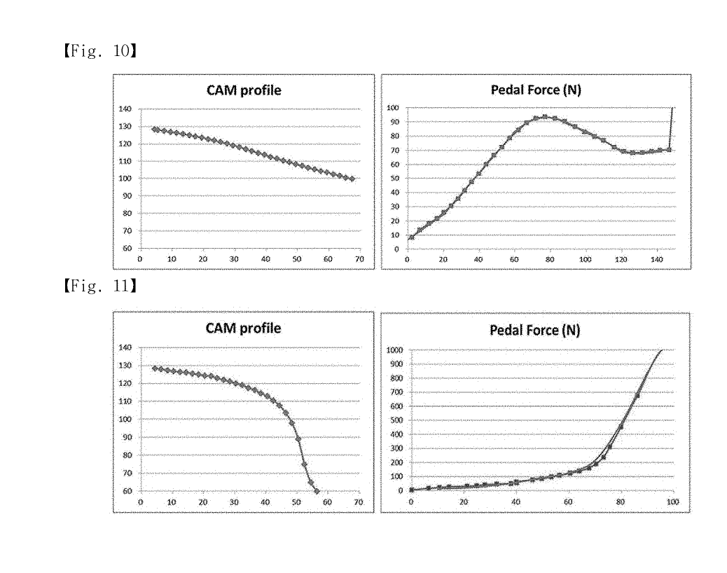

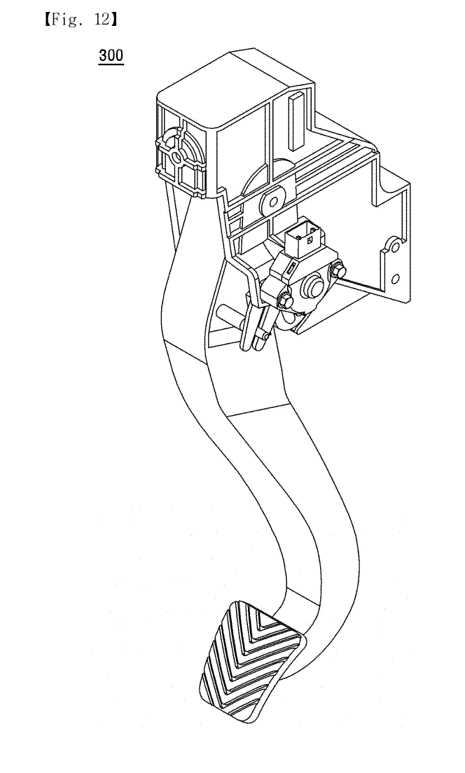

FIG. 10 shows an experimental data of a case where the pedal effort generator according to the first embodiment of the present invention is applied to a clutch pedal. FIG. 11 shows an experimental data of a case where the pedal effort generator according to the first embodiment of the present invention is applied to a brake pedal.

Referring to FIG. 10, data shown in the left side of FIG. 10 shows the shape of the cam 130 and specifically shows the shape of one surface of the cam 130, where the roller 151-1 moves while contacting. Data shown in the right side of FIG. 10 shows the pedal effort when the roller 151-1 moves on the one surface of the cam 130 while contacting with the one surface of the cam 130. This means that the clutch pedal effort that the user wants can be variously obtained by varying the shape of the one surface of the cam 130 where the roller 151-1 moves while contacting.

Also, referring to FIG. 11, data shown in the left side of FIG. 10 shows the shape of the cam 130 and specifically shows the shape of one surface of the cam 130, where the roller 151-1 moves while contacting. Data shown in the right side of FIG. 10 shows the pedal effort when the roller 151-1 moves on the one surface of the cam 130 while contacting with the one surface of the cam 130. This means that the brake pedal effort that the user wants can be variously obtained by varying the shape of the one surface of the cam 130 where the roller 151-1 moves while contacting.

### Second Embodiment 300

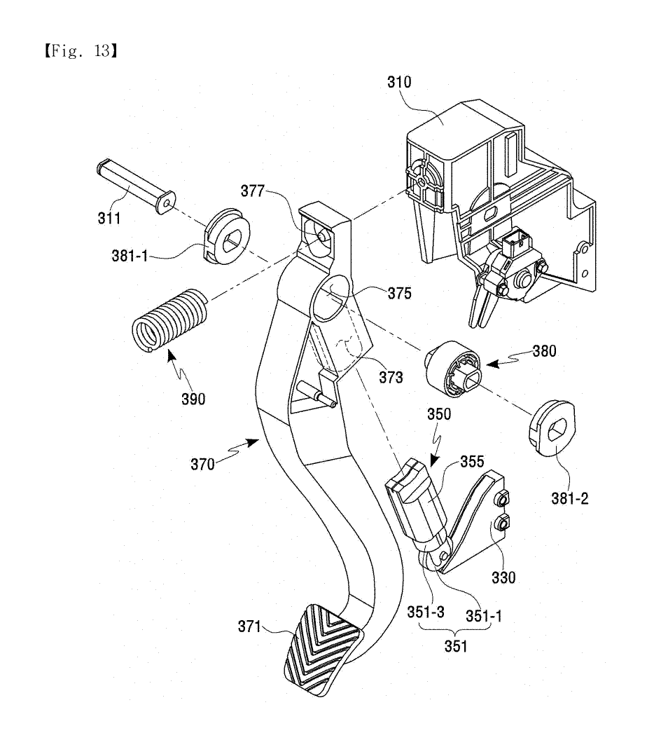

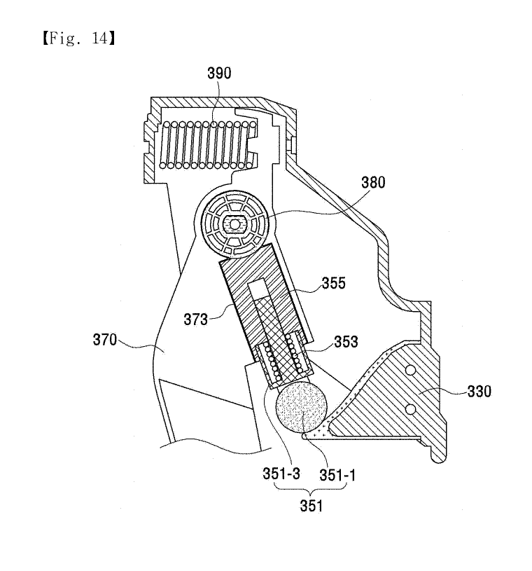

FIG. 12 is a perspective view showing a pedal effort generator according to a second embodiment of the present invention. FIG. 13 is an exploded perspective view of the pedal effort generator of FIG. 12. FIG. 14 is a cross sectional view of the pedal effort generator of FIG. 12.

Referring to FIGS. 12 to 14, the pedal effort generator using a cam 330 according to the first embodiment of the present invention may include a housing 310, a pedal unit 370, the cam 330, a pedal effort generation unit 350, and an elastic member 390. Hereinafter, the components will be each described in detail. However, the same descriptions as those of the housing 110, the pedal unit 170, the cam 130, the pedal effort generation unit 150, and the elastic member 190 which constitute the above-described pedal effort generator using the cam 130 according to the first embodiment of the present invention will be omitted.

The housing 310 of the pedal effort generator according to the second embodiment of the present invention forms the exterior of the pedal effort generator.

A rotating shaft 311 may be disposed within the housing 310. The below-described pedal unit 370 may be connected (fastened) to the rotating shaft 311. The pedal unit 370 is connected to the rotating shaft 311 of the housing 310 and may pivot about the rotating shaft 311. The rotating shaft 311 may be integrally formed with the housing 310 or may be separately manufactured and be coupled to the housing 310.

The pedal unit 370 of the pedal effort generator according to the second embodiment of the present invention refers generally to a portion on which a user's foot steps.

The pedal unit 370 refers generally to a pedal that is manufactured in various shapes and is used in vehicles. The pedal unit 370 according to the embodiment of the present invention may include a pedal pad 371 and a receiving hole 373.

The pedal unit 370 may include one side and the other side. The one side of the pedal unit 370 may include the pedal pad 371 and the below-described receiving hole 373 in which a portion of the pedal effort generation unit 350 is disposed.

The pedal pad 371 is disposed on one side of the pedal unit 370 and is stepped on by a user's foot. The pedal pad 371 may be formed in various shapes so as to allow the user's foot to be comfortably placed thereon.

The receiving hole 373 may be disposed on one side of the pedal unit 370, and a portion of the pedal effort generation unit 350 may be disposed in the receiving hole 373. Specifically, the receiving hole 373 may be formed on one surface forming the one side of the pedal unit 370 or may be formed on one surface between one side and the other side of the pedal unit 370.

The cross sectional shape of the receiving hole 373 may be formed to correspond to that of the exterior of a receiving portion 355 of the pedal effort generation unit 350 to be inserted into the receiving hole 373. However, the cross section of the receiving hole 373 is not limited to this and may have various shapes.

The pedal unit 370 may include a connection portion 375 such as a hole which can be connected to the rotating shaft 311 of the housing 310. Specifically, the rotating shaft 311 of the housing 310 may be connected to a portion between one side and the other side of the pedal unit 370, and the pedal unit 370 may pivot about the rotating shaft 311 of the housing 310. Here, the portion may be the connection portion 375 like a hole. The connection portion 375 may be directly connected to the rotating shaft 311 of the housing 310 or may be indirectly connected to the rotating shaft 311 of the housing 310 by additional components.

The receiving hole 373 may pass through from one surface forming one side of the pedal unit 370 or one surface between one side and the other side of the pedal unit 370 to the connection portion 375.

The pedal unit 370 may further include a bush member 380 which is connected to the rotating shaft 311.

The bush member 380 may be made of various materials. For example, the bush member 380 may be made of an elastic rubber material, an elastic plastic, or a metallic material having a low elasticity.

The bush member 380 may be inserted into the connection portion 375 like the hole of the pedal unit 370 and may be fastened to the rotating shaft 311.

The bush member 380 may come in contact with the receiving portion 355 of the pedal effort generation unit 350 and specifically, can generate the pedal effort through contact with one side of the receiving portion 355.

The shape of the bush member 380 is not specially determined. The bush member 380 can be formed in various shapes capable of generating the pedal effort through contact with the receiving portion 355.

A protrusion may be formed on both sides of the bush member 380. A connection member 381 may be disposed on the protrusions respectively.

A hole may be formed in the central portion of the bush member 380 and in the central portion of the connection member 381 disposed on both sides of the bush member 380 respectively. The rotating shaft 311 may be disposed to be inserted into the hole.

When the user applies force to the pedal pad 371, the pedal unit 370 may pivot about the rotating shaft 311 at a predetermined angle, and the pedal effort generation unit 350 may move along one surface of the cam 330 by the pivoting of the pedal unit 370. One side of the receiving portion 355 of the pedal effort generation unit 350 is in contact with the bush member 380, and the receiving portion 355 transmits an elastic force which is generated in a spring 353 by the movement of a roller unit 351 of the pedal effort generation unit 350 on the one surface of the cam 330 to the bush member 380, so that the pedal effort can be generated.

A below-described elastic member receiving portion 377 which contacts the other side of the elastic member 390 may be formed on the other side of the pedal unit 370.

The elastic member receiving portion 377 may be formed on one surface forming the other side of the pedal unit 370. The elastic member receiving portion 377 may be formed in a shape including a recess or a protrusion so as to allow the other side of the elastic member 390 to be fixed (fastened). Also, there may exist additional components capable of fixing the other side of the elastic member 390.

The cam 330 of the pedal effort generator according to the second embodiment of the present invention may be disposed on the inner surface of the housing 310.

The cam 330 may include one surface on which the below-described roller unit 351 of the pedal effort generation unit 350 moves and the other surface which is coupled to the inner surface of the housing 310.

In accordance with the second embodiment of the present invention, the one surface and the other surface of the cam 330 may be formed as a flat surface or may be formed as a curved or stepped surface.

A roller 351-1 of the roller unit 351 passes the one surface of the cam 330 while rotating by the pivoting of the pedal unit 370, so that the pedal effort can be variously generated according to the shape of the one surface of the cam 330.

By varying the shape of the cam 330 profile, which is formed on the one surface of the cam 330, the pedal effort can be easily generated in various patterns in accordance with a working distance of the roller 351-1 of the roller unit 351 passes. The shape of the one surface of the cam 330 may be formed in various shapes in accordance with required pedal effort patterns.

Since the other surface of the cam 330 is coupled to the inner surface of the housing 310, the other surface of the cam 330 may be formed in a shape corresponding to the inner surface of the housing 310. Specifically, as long as the inner surface of the housing 310 where the cam 330 is disposed is a curved or stepped surface, the cam 330 may be formed in a shape corresponding thereto.

The pedal effort generation unit 350 of the pedal effort generator according to the second embodiment of the present invention may move along the one surface of the cam 330 by the pivoting of the pedal unit 370 and may include the roller unit 351, the spring 353, and the receiving portion 355. Specifically, the roller unit 351 may move along the one surface of the cam 330 by the pivoting of the pedal unit 370, and the spring 353 may be coupled to the roller unit 351. Also, the receiving portion 355 may receive the spring 353.

The roller unit 351 may include the roller 351-1 and a roller support 351-3 which supports the roller 351-1. The roller 351-1 and the roller support 351-3 may be separately manufactured and coupled to each other.

The roller 351-1 may move along the one surface of the cam 330 by the pivoting of the pedal unit 370.

The roller 351-1 may be disposed on one side of the roller support 351-3, and the spring 353 may be disposed on the other side of the roller support 351-3.

Specifically, the roller support 351-3 may include a fixing member, a supporting member, and a coupling member. The fixing member may be connected to the central portion of the roller 351-1 such that the roller 351-1 disposed on one side of the roller support 351-3 can rotate. The supporting member may support the roller 351-1 and one side of the supporting member may be connected to the fixing member. The coupling member may be connected to the other side of the supporting member and may be coupled to the below-described spring 353 disposed on the other side of the roller support 351-3. The fixing member, the supporting member, and the coupling member may be integrally formed with each other or may be separately manufactured and coupled.

The spring 353 may be disposed on the other side of the roller support 351-3, that is, below the roller support 351-3. Specifically, the spring 353 may be disposed on the coupling member connected to the other side of the supporting member of the roller support 351-3. Also, the spring 353 may be disposed to be received in the receiving portion 355.

As the roller 351-1 moves along one surface of the cam 330 by rotating, the length of the spring 353 may change and the length change of the spring 353 may generate an elastic force (pedal effort).

The receiving portion 355 may be disposed in the receiving hole 373 of the pedal unit 370. One side of the receiving portion 355 may come in contact with the bush member 380.

According to the second embodiment of the present invention, the receiving portion 355 may have a recess capable of receiving a portion of the roller support 351-3 and either the spring 353 or a portion of the spring 353. Specifically, the recess may receive a portion of the coupling member and/or the supporting member of the roller support 351-3 and may receive the entire or a portion of the spring 353.

The cross sectional shape of the exterior of the receiving portion 355 may correspond to the cross sectional shape of the receiving hole 373 because the receiving portion 355 is disposed in the receiving hole 373 of the pedal unit 370. However, the receiving portion 355 comes in contact with the bush member 380 within the receiving hole 373 and transmits the elastic force of the spring 353 disposed in the receiving portion 355 to the bush member 380, so that the pedal effort is generated. Therefore, as long as the receiving portion 355 is able to perform the above-described function, the cross sectional shape of the receiving portion 355 may not correspond to the cross sectional shape of the receiving hole 373.

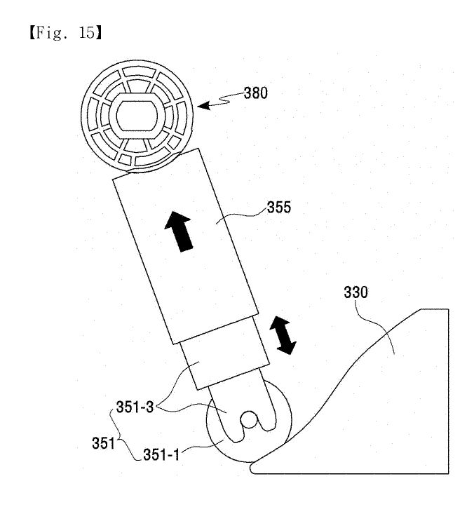

FIG. 15 is a view showing a principle of generating the pedal effort in the pedal effort generator of FIG. 12.

Referring to FIG. 15, when the user applies force to the pedal pad 371, the pedal unit 370 may pivot about the rotating shaft 311 at a predetermined angle, and the roller 351-1 may move along one surface of the cam 330 by the pivoting of the pedal unit 370. One side of the receiving portion 355 is in contact with the bush member 380, the length of the spring 353 changes by the movement of the roller 351-1 on the one surface of the cam 330, and then the length change of the spring 353 generates an elastic force. The receiving portion 355 transmits the elastic force to the bush member 380, so that the pedal effort can be generated.

The elastic member 390 of the pedal effort generator according to the first embodiment of the present invention is disposed between the inner surface of the housing 310 and the other side of the pedal unit 370 to apply an elastic force to the pedal unit 370.

The elastic member 390 absorbs or accumulates energy by using elastic deformation of an object and acts as a buffer, etc. According to the second embodiment of the present invention, a typical spring may be used. Also, a variety of elastic objects or elastic devices other than the spring may be used.

When the user pivots the pedal unit by applying force to the pedal pad 171, the elastic member 190 may return the pedal unit which has pivoted at an angle in a predetermined range to its original position.

According to the second embodiment of the present invention, the elastic member 390 can be placed in various locations within the housing 310. According to the first embodiment of the present invention, the elastic member 390 may be placed outside the housing 310.

One side of the elastic member 390 shown in FIGS. 13 and 14 may contact with the inner surface of the housing 310, and the other side of the elastic member 390 may contact with the other side of the pedal unit 370. Specifically, the other side of the elastic member 390 may be disposed in the elastic member receiving portion 377 formed on the other side of the pedal unit 370.

The elastic member receiving portion 377 may be formed on one surface forming the other side of the pedal unit 370 or may be formed in a shape including a recess or a protrusion so as to allow the other side of the elastic member 390 to be fixed (fastened). Also, there may exist additional components capable of fixing the other side of the elastic member 390.

In the pedal effort generators using the cam according to the embodiments of the present invention, by varying the shape of the one surface of the cam which comes in contact with the roller, it is possible to adjust the pedal effort of various pedals which are commonly used in a vehicle such as an accelerator pedal, a clutch pedal, and a brake pedal, etc., to the pedal efforts that the user wants.

Also, in the pedal effort generators using the cam according to the embodiments of the present invention, the pedal effort of can be freely changed according to the shape of the cam. Since the pedal effort generator has a simple structure and excellent durability, the production cost thereof can be reduced.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A pedal effort generator comprising:
a housing which comprises a rotating shaft disposed therewithin;
a cam which is disposed on an inner surface of the housing;
a pedal effort generation unit which moves along one surface of the cam;
a pedal unit which comprises a pedal pad disposed on one side thereof and comprises a receiving recess in which a portion of the pedal effort generation unit is disposed on the other side thereof, a portion of between the one side and the other side which is connected to the rotating shaft of the housing and is pivotable about the rotating shaft; and
an elastic member which is disposed between the inner surface of the housing and the other side of the pedal unit to apply an elastic force to the pedal unit,
wherein the pedal effort generation unit comprises a roller unit which moves along one surface of the cam by the pivoting of the pedal unit and comprises a spring which is coupled to the roller unit,
wherein the roller unit comprises a roller which moves along the one surface of the cam and comprises a roller support which supports the roller,
and wherein the spring is disposed below the roller support.

2. The pedal effort generator of claim 1, wherein a length of the spring changes by the movement of the roller unit on the one surface of the cam, and the length change of the spring generates the pedal effort.

3. A pedal effort generator comprising:
a housing which comprises a rotating shaft disposed therewithin;
a cam which is disposed on an inner surface of the housing;
a pedal effort generation unit which moves along one surface of the cam;
a pedal unit which comprises one side and the other side, the one side comprising a pedal pad and a receiving hole in which a portion of the pedal effort generation unit is disposed, a portion of between the one side and the other side which is connected to the rotating shaft of the housing and is pivotable about the rotating shaft; and
an elastic member which is disposed between the inner surface of the housing and the other side of the pedal unit to apply an elastic force to the pedal unit,
wherein the pedal effort generation unit comprises a roller unit moving along one surface of the cam by the pivoting of the pedal unit, comprises a spring which is coupled to the roller unit, and comprises a receiving portion which receives the spring,
wherein the roller unit comprises a roller which moves along the one surface of the cam and comprises a roller support which supports the roller,
and wherein the spring is disposed below the roller support.

4. The pedal effort generator of claim 3, wherein the pedal unit further comprises a bush member which is connected to the rotating shaft.

5. The pedal effort generator of claim 3,
wherein the pedal unit further comprises a bush member which is connected to the rotating shaft,
wherein one side of the receiving portion comes in contact with the bush member,
and wherein the receiving portion transmits an elastic force which is generated in the spring by the movement of the roller unit on the one surface of the cam to the bush member, so that the pedal effort is generated.
